(19) United States
(12) Patent Application Publication
(10) Pub. No.: US 2006/0067068 A1
(43) Pub. Date: Mar. 30, 2006

(54) Digital cross-connect system and rack arrangement

(76) Inventors: Cyle D. Petersen, Belle Plaine, MN (US); Scott K. Baker, Richfield, MN (US)

Correspondence Address: MERCHANT & GOULD PC, P.O. BOX 2903, MINNEAPOLIS, MN, 55402-0903, US

(21) Appl. No.: 10/952,458

(22) Filed: Sep. 27, 2004

(51) Int. Cl. H01R 12/16

(52) U.S. Cl. 361/788

(57) ABSTRACT

The disclosure relates to a telecommunications bay having a frame including a front and a rear. A plurality of chassis mounted is the front of the frame. An IN/OUT cable termination region and accessible cross-connect cable termination region are accessible from the rear of the frame. The cross-connect cable termination region is segregated from the IN/OUT cable termination region. Normal-through switching circuitry is housed within the chassis. The normal-through switching circuitry of each chassis is electrically connected to the IN/OUT cable termination region by first cables that extend through an interior region of the frame, and the normal-through switching circuitry of each chassis is electrically connected to the cross-connect cable termination region by second cables routed through the interior region of the frame. Front ports provide plug access to the normal-through switching circuitry. The bay also includes center conductors and shield contacts corresponding to the ports for providing electrical connections with coaxial plugs inserted within the ports.

### TECHNICAL FIELD

The present disclosure relates generally to telecommunications equipment. More particularly, the present disclosure relates to a digital cross-connect system and frame arrangement.

### BACKGROUND

In the telecommunications industry, the use of switching jacks to perform digital cross-connect (DSX) and monitoring functions is well known. The jacks may be mounted to replaceable cards or modules, which in turn may be mounted in a chassis, and multiple chassis may be mounted together in an equipment rack. Modules for use in co-axial environments (i.e., DS3 environments) are described in U.S. Pat. No. 5,913,701, which is incorporated herein by reference. Modules for use in twisted pair applications are described in U.S. Pat. No. 6,116,961, which is also incorporated herein by reference. Cross-connect modules are also used with fiber optic communications systems.

FIG. 1 shows a prior art cross-connect arrangement of the type used for co-axial applications. The depicted arrangement includes two jack modules 320, 322. The jack modules 320, 322 may be mounted in separate chassis that are in turn mounted on separate racks. Each jack module 320, 322 is cabled to a separate network element (i.e., piece of telecommunications equipment). For example, jack module 320 is connected to equipment 324 by cables 326, and jack module 322 is connected to equipment 328 by cables 330. The pieces of equipment 324 and 328 are interconnected by cross-connect jumpers 332 placed between the two jack modules 320 and 322. Each jack module 320, 322 includes IN and OUT ports 334 and 336 for direct access to the equipment's input and output signals. Each module 320, 322 also includes X-_{IN} and X-OUT ports 335, 337 for providing direct access to the cross-connect input and cross-connect output signals. Ports 334-337 provide a means to temporarily break the connection between the pieces of equipment 324 and 328 that are cross-connected together, and to allow access to the signals for test and patching operations. The jack modules 320, 322 also include monitor ports 338 for non-intrusive access to the input and output signals of each piece of telecommunications equipment 324, 328.

A typical telecommunications central office includes many jack modules and a large number of bundled cables interconnecting the modules. Consequently, absent indicators, it is difficult to quickly determine which two jack modules are cross-connected together. To assist in this function, the jack modules 320, 322 include indicator lights 340 wired to power 342 and ground 344. Switches 346 are positioned between the indicator lights 340 and ground 344. The indicator lights 340 are also electrically connected to pin jacks 348 located at the rear of the jack modules 320, 322. The pin jacks 348 provide connection locations for allowing the tracer lamp circuits corresponding to each of the modules 320, 322 to be interconnected by a cable 350 (i.e., a wire). The cable 350 is typically bundled with the cross-connect cables 332. When either switch 346 is closed, the indicator lamps 340 corresponding to both of the jack modules 320, 322 are connected to ground and thereby illuminated. Thus, by closing one of the switches 346, the two jack modules 320, 322 that are cross-connected can be easily identified by merely locating the illuminated tracer lamps. Examples of tracer lamp units are described in U.S. Pat. No. 4,840,568, 5,145,416, and 5,393,249, the entire disclosures of which are incorporated herein by reference.

### SUMMARY

In one aspect, the present disclosure relates to a high-density cross-connect telecommunications system for use in coaxial applications. In another aspect, the present disclosure relates to a bay having an improved cable management arrangement.

A variety of aspects of the invention are set forth in part in the description that follows, and in part will be apparent from the description, or may be learned by practicing various aspects of the disclosure. The aspects of the disclosure may relate to individual features as well as combinations of features. It is to be understood that both the foregoing general description and the following detailed description are exemplary and explanatory only, and are not restrictive of the claimed invention.

### BRIEF DESCRIPTION OF THE DRAWING

FIG. 1 is a schematic diagram of a prior art DSX system;

FIG. 2 is a side elevational view of a DSX bay that is an embodiment in accord with the present disclosure;

FIG. 3 is a front perspective view of the bay of FIG. 2;

FIG. 3A is a detailed view of a portion of FIG. 3;

FIG. 4 is a rear perspective view of the bay of FIG. 2;

FIG. 5 is a rear elevational view of the bay of FIG. 4;

FIG. 6 is a front perspective view of a chassis of the bay of FIG. 2 that is an embodiment in accord with the present disclosure;

FIG. 7 is a front perspective view of the chassis of FIG. 6 shown without jack modules;

FIG. 8 is a front elevational view of the chassis of FIG. 7;

FIG. 8A is a cross-sectional view taken along section line 8A-8A of FIG. 8, a jack insert is shown within the chassis;

FIG. 9 is a rear perspective view of a rear interface assembly of the chassis of FIG. 7;

FIG. 10 is a schematic diagram of a DSX circuit provided by one of the jack modules of FIGS. 6 and 9;

FIG. 11 is a schematic diagram of a DSX circuit provided by the bay of FIGS. 2-5;

FIG. 12 is a front perspective view of the bay of FIG. 3, shown with only two chassis mounted to a frame of the bay;

FIG. 13 is a partial, rear perspective view of the bay of FIG. 4, shown with connectors mounted to panels located in an upper region of the frame of the bay;

FIG. 14 is a schematic diagram of a cross-aisle application of the bay of FIG. 2;

FIG. 15 is a schematic top-view diagram of a floor layout including a number of bays of the type shown at FIG. 2;

FIG. 16 is a top view of the bay of FIG. 2;

FIG. 17 is a rear view of the IN/OUT termination region of the bay of FIG. 2;

FIG. 18 is a rear view of the CROSS-AISLE termination region of the bay of FIG. 2;

FIG. 19 is a rear view of the CROSS-CONNECT termination region of the bay of FIG. 2;

FIG. 20 shows circuitry for a jack module used with the bay of FIG. 2;

FIG. 21 is a schematic a normal-through circuit configuration for one of the jack inserts of the module of FIG. 20;

FIG. 22 is a circuit configuration for the insert of FIG. 21 with a plug inserted in the OUT port; and

FIG. 23 is a circuit configuration for the insert of FIG. 21 with a plug inserted in the X-OUT port.

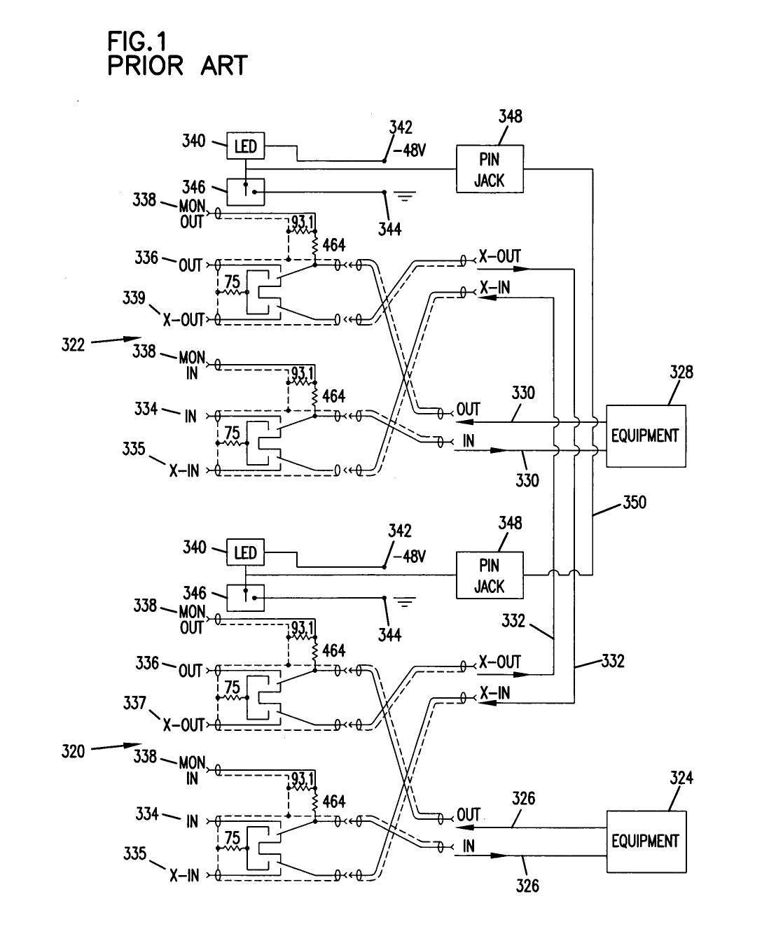

### DETAILED DESCRIPTION

Reference will now be made in detail to exemplary aspects of the present disclosure that are illustrated in the accompanying drawings. Wherever possible, the same reference numbers will be used throughout the drawings to refer to the same or like parts.

I. Brief General Overview of the Disclosure

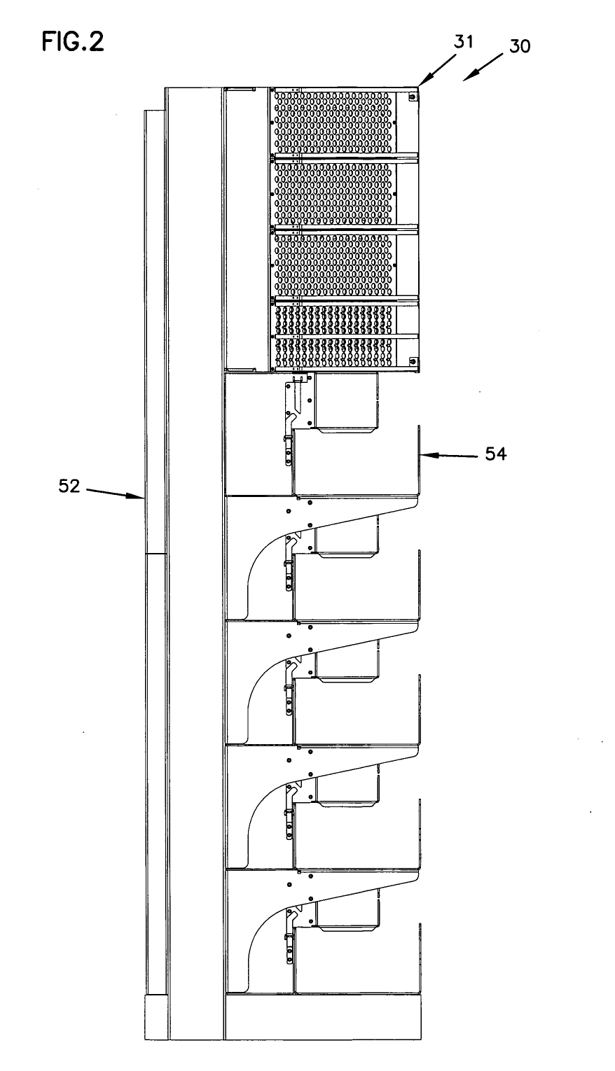

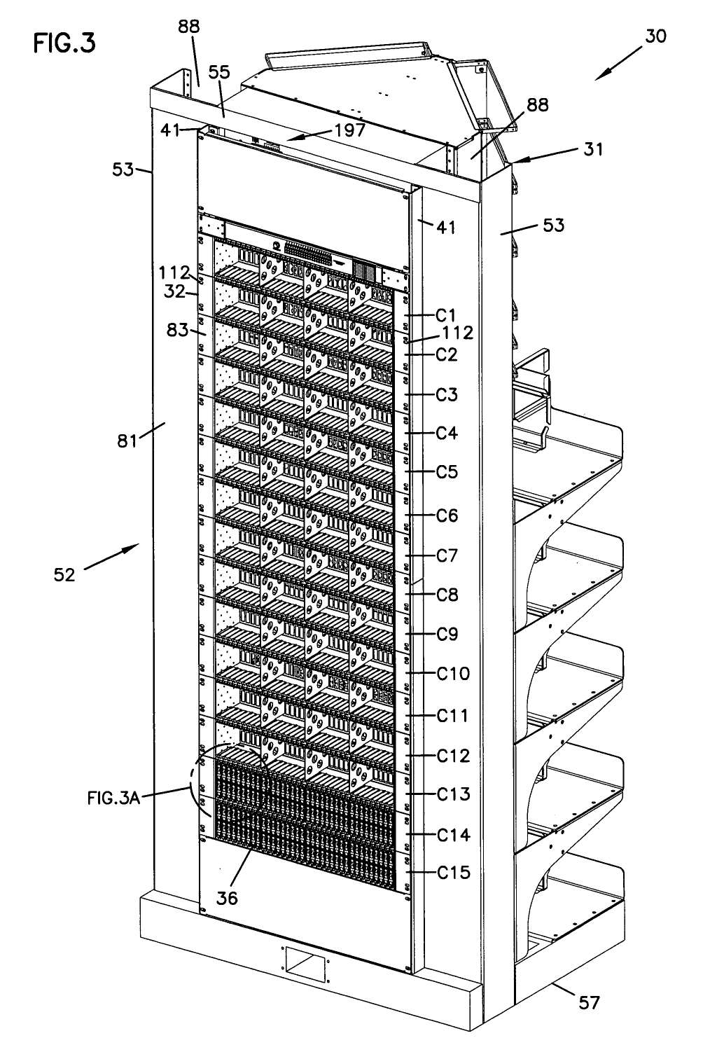

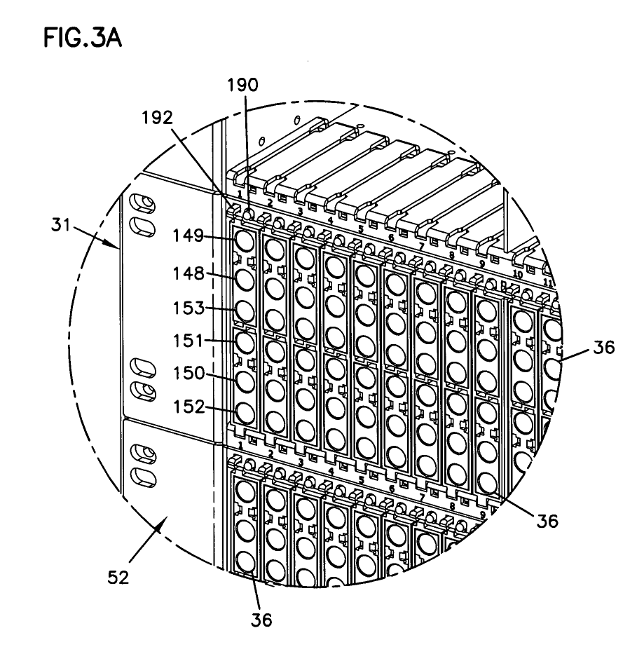

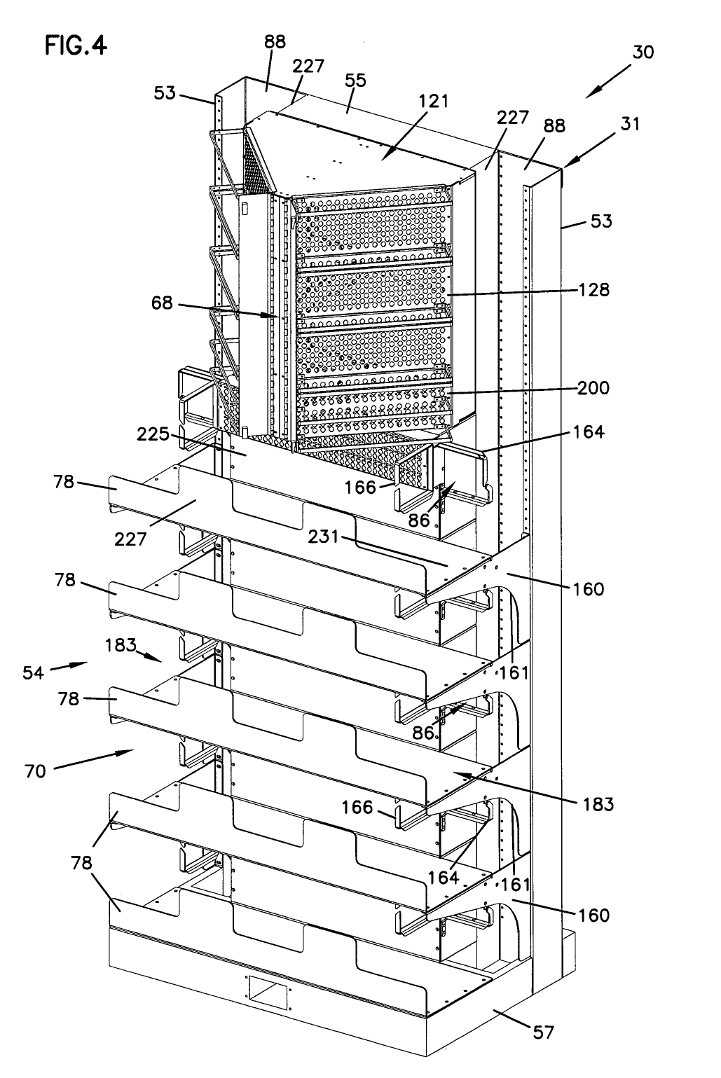

FIGS. 2-5 illustrate a DSX system 30 that is one embodiment of the present disclosure. The DSX system 30 includes a bay 31 having a front side 52 (FIG. 3) and a rear side 54 (FIGS. 4 and 5). The front side 52 provides signal access (e.g., via DS3 monitor and DS3 switching jacks) for signal interruption, testing, monitoring, patching or other functions. As shown in FIG. 3A, rows of OUT ports 148, MONITOR OUT ports 149, IN ports 150, MONITOR IN 151, CROSS-CONNECT IN ports 152 and CROSS CONNECT OUT ports 153 are provided at the front side 52 for allowing co-axial plugs to be inserted into the monitor and switching jacks.

As shown at FIG. 4, the rear side 54 of the bay 31 provides locations for terminating IN and OUT cables (i.e., cables connected to equipment) as well as CROSS-CONNECT cables. In the depicted embodiment, the IN and OUT termination locations are segregated (i.e., separated or kept apart from) the CROSS-CONNECT termination locations. For example, as shown best at FIG. 5, the IN and OUT termination locations are all grouped at an IN/OUT termination region 68 located at an upper portion 56 of the bay 31. By contrast, all of the CROSS-CONNECT termination locations are grouped at a CROSS-CONNECT termination region 70 located at a lower portion 58 of the bay 31. A CROSS-AISLE termination region 200 is located between the IN/OUT termination region 68 and the CROSS-CONNECT termination region 70.

Cable management structures such as horizontal troughs 78 (i.e., channels) and vertical troughs 88 (i.e., channels) are provided adjacent the rear side 54 to promote cable management. By segregating the IN/OUT termination region from the CROSS-CONNECT termination region, cross-connect cables can be kept separate from equipment cables to improve cable management. For example, only the cross-connect cables would typically be routed through the horizontal troughs 78. In addition, the cross-connect cables and equipment cables would use different vertical sections of the vertical troughs 88. In the depicted embodiment, the cross-connect cables would be routed through lower sections of the vertical troughs 88 and the equipment cables would be routed through upper sections of the vertical troughs 88.

The depicted embodiment is adapted for facilities having equipment cables routed through the ceilings of the facilities. In alternative embodiments, the relative positioning of the CROSS-CONNECT termination region and the IN/OUT termination region can be varied. For example, for floor mount facilities, the IN/OUT region can be located adjacent the bottom of the bay and the CROSS-CONNECT region can be located adjacent the top of the bay.

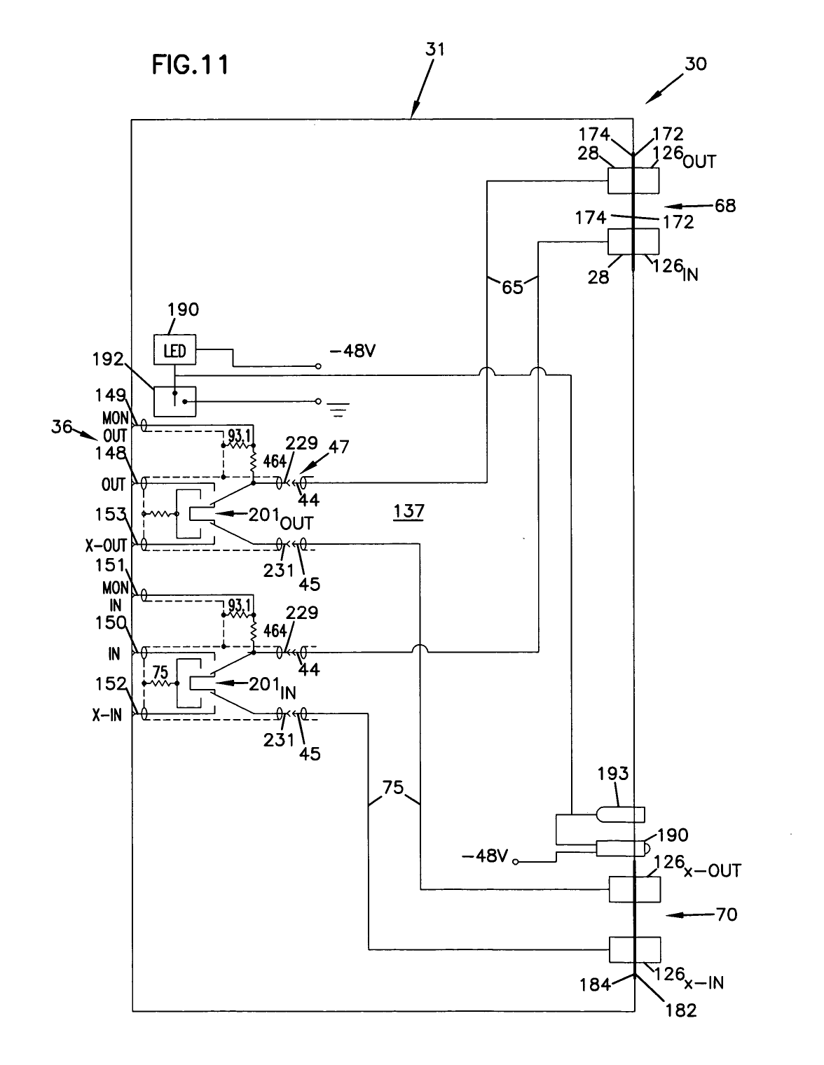

In general, the DSX system 30 provides normal-through electrical circuit pathways between the IN/OUT termination locations at region 68 and the CROSS-CONNECT termination locations at region 70. An example normal-through circuit pathway configuration is schematically shown at FIG. 11. Referring to FIG. 11, IN and OUT co-axial connectors 126_{IN}, 126_{OUT} at the region 68 are connected to switching circuitry 201_{IN}, 201_{OUT} at the front of the bay 31 by co-axial cables 65 that extend through the interior of the bay 31. Similarly, CROSS-CONNECT IN and CROSS-CONNECT OUT connectors 126_{X-IN}, 126_{X-OUT} at the region 70 are connected to the switching circuitry 201_{IN} and 201_{OUT} by co-axial cables 75 that extend through the interior of the bay 31. In this way, a first circuit path extends from the connector 126_{OUT}, through the switching circuitry 201_{OUT} to the connector to the connector 126_{X-OUT}, and a second circuit path extends from the connector 126_{IN}, through the switching circuitry 201_{IN}, to the connector 126_{X-IN}. The circuit paths are “normal-through”, because the switching circuitry 201_{IN}, 201_{OUT} is normally configured as shown in FIG. 11. Thus, when no plugs are inserted within the ports 148, 150, 152 and 153, the switching circuitry 201_{OUT}, 201_{IN} does not interrupt the electrical pathways between the connectors 126_{OUT} and 126_{X-OUT}, and between the connectors 126_{IN} and 126_{X-IN}. When a plug is inserted into either of the ports 148, 153, the normal-through connection between the connector 126_{OUT} and connector 126_{X-OUT} is broken by the switching circuitry 201_{OUT}. Similarly, when a plug is inserted into either of the ports 150, 152, the normal-through connection between the connector 126_{IN} and connector 126_{X-IN} is broken by the switching circuitry 201_{IN}. It will be appreciated that switching circuitry of this type is conventionally known in the art (e.g., see U.S. Pat. Nos. 6,589,062 and 4,749,968, which are hereby incorporated by reference). Ports 149, 152 provide non-intrusive monitor access to signals carried by the electrical pathways.

II. DSX Bay

Referring to FIG. 3, the bay 31 of the DSX system 30 includes a support frame including two vertical rack rails 53. Bottom ends of the rack rails 53 are mounted to a base 57 that stabilizes the frame and defines a footprint of the bay 31. One or more cross-bracing members preferably reinforce the rack rails 53. For example, as shown at FIG. 3, a top plate 55 extends between top ends of the rack rails 53 to provide cross-bracing. The vertical cable troughs 88 are defined within the rack rails 53.

a. Front Jack Access

The front side 52 of the bay 31 is configured to receive the plurality of chassis 32. For example, as shown at FIG. 3, the chassis 32 are mounted between front stand-off channels 41 fastened to the front sides of the rack rails 53. Flanges 112 of the chassis 32 can be secured to the channels 41 by conventional fasteners (e.g., bolts, screws or other fasteners). In some applications, forward facing surfaces 81, 83 of either the chassis flanges 112 or the frame can be used to attach or adhere designation labels that identify the individual circuits. In other applications, hinged panels or doors (not shown) can be secured to the frame, or the chassis 32 to cover the forward facing surfaces 81, 83 and provide additional area upon which identification material can be located.

Jack modules 36 are removably mounted within each of the chassis 32. The jack modules 36 include front faces that define the access ports 148-153. Switching and monitoring circuitry corresponding to the access ports 148-153 are incorporated into the modules 36. While it is preferred for the modules 36 to be removable from the chassis, non-removable and non-modular embodiments are also within the scope of the present disclosure.

b. Rear IN/OUT and CROSS-Aisle Termination Regions

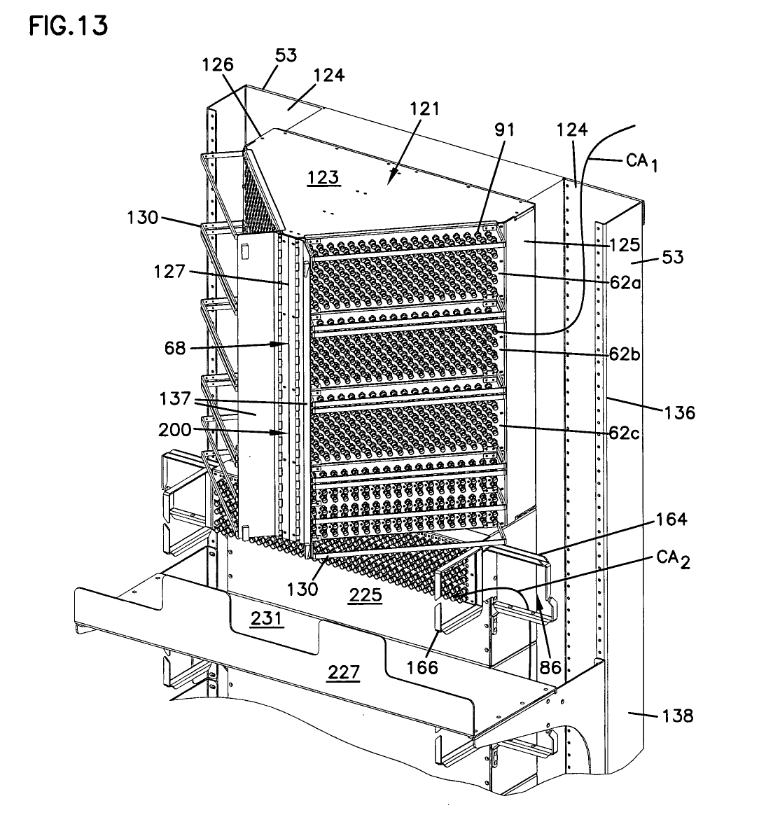

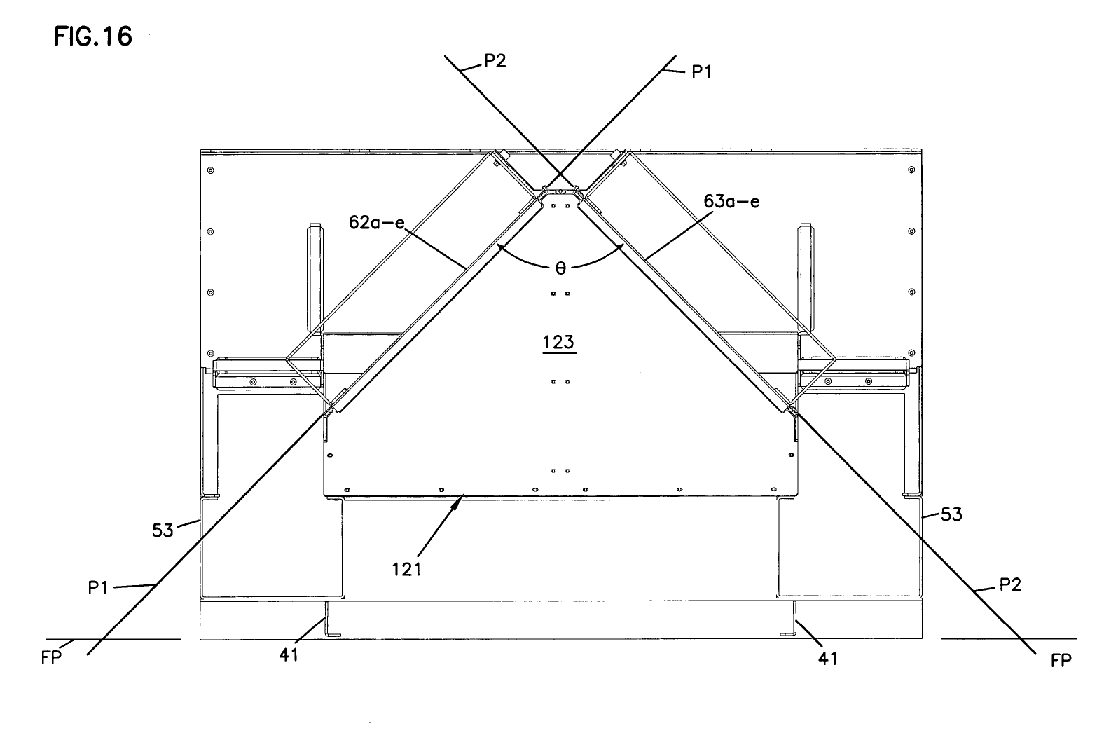

Referring now to FIGS. 4, 5 and 13, the IN/OUT termination region 68 is provided at connector mounting panels 62a-c and 63a-c positioned at the upper portion 56 of the bay 31. The panels 62a-c and 63a-c are mounted to a panel mounting construct 121 secured between the rack rails 53 at the back side of the bay 31. As shown at FIG. 13, the panel mounting construct 121 is secured to the back sides of the rack rails 53 adjacent the top of the bay 31. The construct 121 includes a top wall 123, two vertical side walls 125, 126, and a rear wall 127. The connector mounting panels 62a-c are mounted between the side wall 125 and the rear wall 127, and the connector mounting panels 63a-c are mounted between the side wall 126 and the rear wall 127. As shown at FIG. 16, the panels 62a-c are aligned along a vertical plane P1 that is angled relative to a vertical front plane FP defined by the front of the bay 31. The panels 63a-c are aligned along a vertical plane P2 that is also angled relative to the front plane FP of the bay 31. To promote circuit density and cable management, the planes P1 and P2 are angled relative to one another as indicated by angle θ. The relative angling of the planes P1 and P2 causes the panels 62a-62c and 63a-63c to converge toward one another as the panels 62a-62c and 63a-63c extend in a rearward direction (i.e., toward the rear wall 127).

The construct 121 functions to offset the panels 62a-c, 63a-c from the rack rails 53. This offset provides more space for routing the interior cables 65 (shown at FIG. 11) through the interior of the rack 31. The angling of the panels 62a-62c, 63a-63c provided by the construct 121 also functions to provide increased surface area for mounting connectors in a given bay width, and to facilitate the lateral and forward routing of equipment cables from the panels 62a-c, 63a-c to the vertical troughs 88.

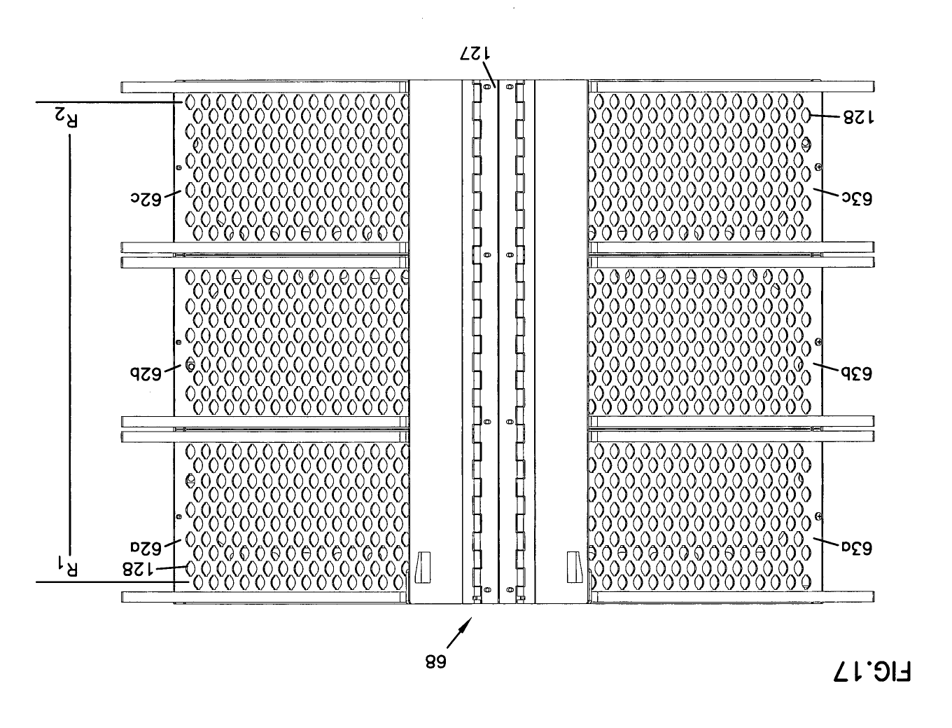

The panels 62a-c, 63a-c are adapted for mounting a plurality of cable termination elements such as co-axial connectors. To achieve this end, the panels 62a-62c and 63a-63c define a plurality of connector mounting openings 128 (best shown at FIG. 17) in which connectors can be secured. For clarity, the majority of the Figures do not show connectors mounted within the openings 128. One notable exception is FIG. 13, where connectors are shown mounted within the openings 128 defined by the panels 62a-c. In one embodiment, the connectors include snap-fit housings 91 (see FIG. 13) for retaining the connectors within the openings 128. Further details regarding the snap-fit housings 91 are provided at U.S. patent application Ser. No. (not yet known), having attorney docket No. 2316.1852US01, entitled High Density Mount for a Co-Axial Connector, and filed on a date concurrent with this application, which is hereby incorporated by reference.

In use, connectors mounted to the panels 62a-c, 63a-c are intended for connection to IN and OUT equipment cables. Hence, as shown in FIG. 11, the connectors have been labeled 126_{IN} and 126_{OUT}. The connector openings 128 are arranged in horizontal rows labeled R1-R30 at FIG. 17. The connector openings 128 of the odd rows are staggered relative to the connectors of the even rows to improve the connector density of the panels 62a-c, 63a-c. It will be appreciated that the organization of the IN and OUT connectors will depend on customer preference. In the one embodiment, the IN and OUT connectors can be segregated from one another within the IN/OUT termination region 68. For example, all of the IN connectors can be mounted at one side of the construct 121 (e.g., at panels 62a-c), while all of the OUT connectors can be mounted at the other side of the construct 121 (e.g., at panels 63a-c). In other embodiments, both IN and OUT connectors can be provided at each of the panels 62a-c, 63a-c, or any selected one of the panels can include either IN or OUT connectors.

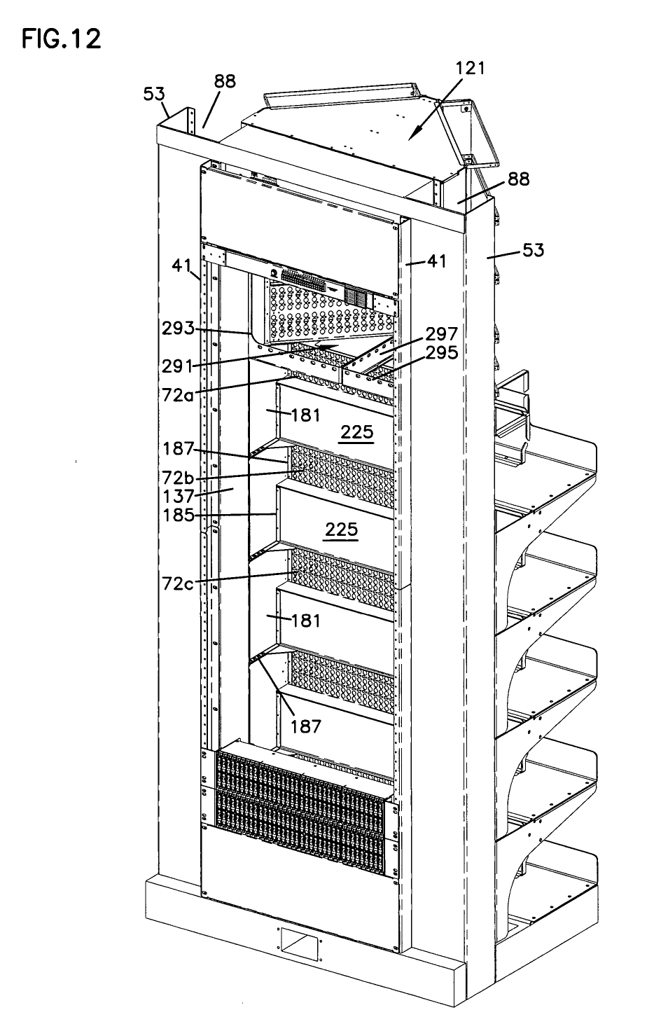

FIG. 11 schematically shows a pair of connectors 126_{IN}, 126_{OUT} mounted within openings 128 in the panels 62a, 63a. At rear sides 172 of the panels 62a, 63a, the connectors 126_{IN}, 126_{OUT} are exposed for ready access by a user. At front sides 174 of the panels 62a, 63a, the connectors 126_{IN}, 126_{OUT} are terminated to cables 65 that electrically connect the connectors 126_{IN}, 126_{OUT} to their corresponding jack module 36. It will be appreciated that the front sides 174 of the panels 62a, 63a face an open interior 291 of the construct 121 (shown at FIG. 12) through which cables 65 can be routed. A front side 293 of the construct 121 is open to allow cable to be readily routed between the interior of the construct 121 and an open cable passage region 137 defined by the bay (e.g., between the rack rails 53). FIG. 12 also shows braces 295 for reinforcing the construct 121. The braces are shown including tie-down openings 297 for allowing cables 65 to be tied to the braces to promote cable management.

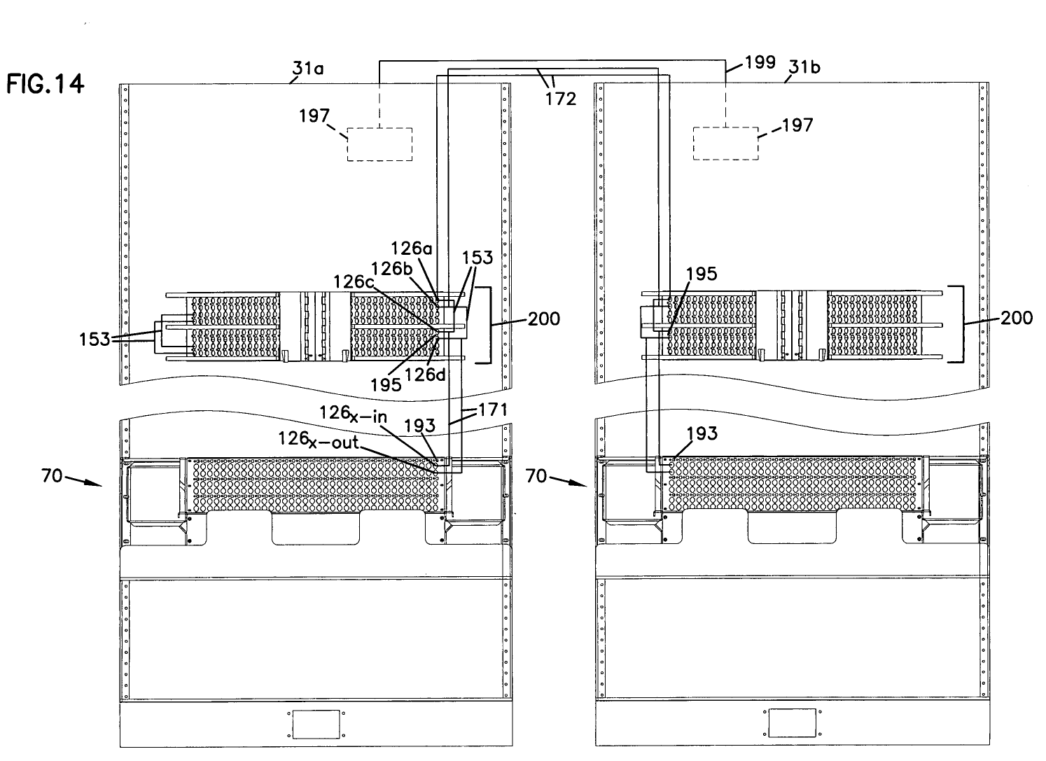

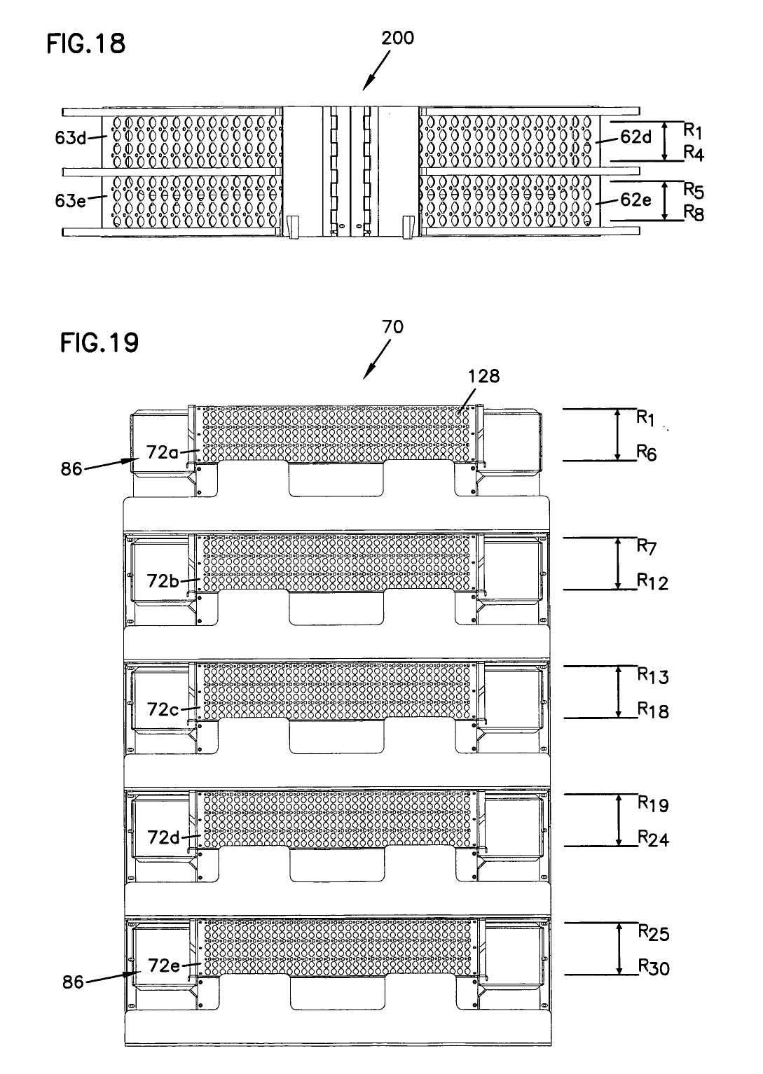

Referring back to FIG. 5, the CROSS AISLE termination region 200 is provided by panels 62d-e and 63d-e mounted to the panel mounting construct 121 beneath the panels 62a-c and 63a-c (see FIG. 13). The panels 62d-e are aligned along plane P1 (FIG. 16) and the panels 63d-e are aligned along plane P2. In one embodiment, the panels 62d and 63d function as CROSS-AISLE OUT panels and include rows 1-4 (labeled at FIG. 18), and panels 62e and 63e function as CROSS-AISLE IN panels and include rows 5-8 (labeled at FIG. 18). Cable loops 153 hidden within the construct 121 connect the connectors of rows 1-4 respectively to the connectors of rows 5-8 (see schematic of FIG. 14).

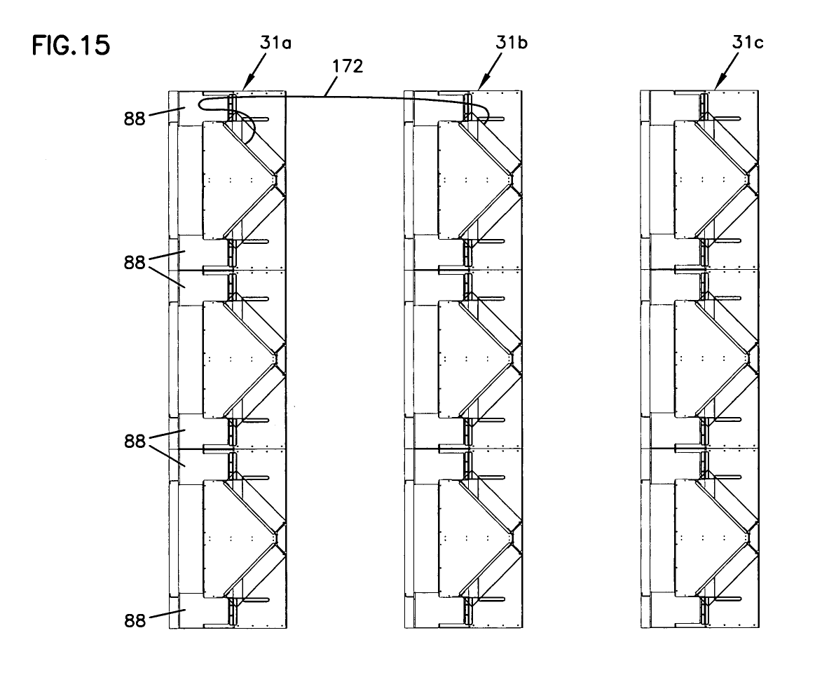

Connectors mounted to panels 62d-e, 63d-e are intended for use in facilitating making cross-connections that extend across an aisle of a facility where the multiple rows of bays 31 are located (e.g., see rows 31A-31C at FIG. 15). The connectors include first pairs of co-axial connectors 126a, 126b (at rows 1 and 2, respectively) that are connected to second pairs of co-axial connectors 126c, 126d (at rows 5 and 6, respectively) by cable loops 153 (see FIG. 14). The cable loops 153 are provided within the interior of the housing 121. In use, as shown schematically in FIGS. 14 and 15, the connectors 126a, 126b of bay 31a are connected to cross-connect connectors 126_{X-IN}, 126_{X-OUT} of bay 31a by cables 171. Cross-aisle cables 172 are used to extend the cross-connection over an aisle to another bay 31b. The cables 172 are connected to connectors 126c, 126d provided at both bays 31a, 31b. The connectors 126c, 126d at bay 31b are cable looped to connectors 126a, 126b also provided at bay 31b. The connectors 126a, 126b of bay 31b are connected to cross-connect connectors 126_{X-IN}, 126_{X-OUT} of bay 31b to complete the cross-connection. The looped connectors at rows 3-4 and 7-8 can be used in a similar manner to provide cross-aisle connections.

Referring back to FIG. 13, the rack rails 53 are located at opposite sides of the bay 31. Each of the rails 53 defines one of the vertical cable troughs 88. The troughs 88 each have an open side that faces in a rearward direction. The vertical troughs 88 extend from the bottom to the top of the bay 31, and have open top ends 124 for allowing IN and OUT equipment cables, as well as cross-aisle cables, to be fed into and out of the bay 31. A first section 136 (FIG. 4) of each of the troughs 88 is located in the upper region 56 of the bay 31 and a second section 138 of each of the troughs 88 is located in the lower region 58 of the bay 31.

Referring to FIG. 15, a schematic representation of a floor layout having a number of bays is shown. The illustrated floor layout includes three rows of bays 31A-31C. The bays are positioned such that the frames bays abut one another. In conventional layouts, cable management panels or extensions are typically positioned between the bays for vertical routing of cables. In the present disclosure, vertical cable routing is accomplished within the bays via troughs 88 to eliminate the need of added panels or extensions.

In use, cables CA₁ (FIG. 13) are routed from, for example, the ceiling of the surrounding area. The cables CA₁ are typically outside equipment cables or cross-aisle cables. The cables CA₁ enter the top of the bay 31 at the open ends 124 of the troughs 88, and are routed downwardly through the troughs 88. From the troughs 88, the cables CA₁ are routed rearwardly to the panels 62a-e, 63a-e where the cables are terminated to the appropriate connectors. To maintain cable organization, the panels 62a-e, 63a-e preferably includes at least one cable management device. The cable management device can include, for example, tie down bars, rings, fingers, loops, brackets, or punch-out areas. In the illustrated embodiment, the cable management device includes cable tie-down brackets/bars 130 provided above and below each of the panels 62a-e, 63a-e. To provide increased surface area for affixing circuit designation information, hinged panels 137 are pivotally mounted to the rear wall 127 of the construct 121.

c. Cross-Connect Region

Referring to FIG. 5, the cross-connect region 70 includes a plurality of cross-connect termination panels 72. For example, the depicted embodiment includes five vertically spaced apart panels 72a-e. The panels 72a-e are oriented generally parallel to the vertical front plane FP of the bay 31. To promote cable management, a separate horizontal cable trough 78 is mounted beneath each of the panels 72a-e. As shown at FIG. 4, each of the troughs 78 has a generally U-shaped transverse cross-section including a front wall 225, a rear wall 227, a bottom wall 231 and open ends 183.

As shown at FIG. 12, brackets 181 are used to secure the panels 72a-d and the troughs 78 to the rack rails 53 of the bay 31. The brackets 181 each include lower portions 185 fastened to the front walls 225 of the troughs 78, and upper portions 187 fastened to the panels 72a-e. The brackets 181 are generally L-shaped such that upper portions 181 project rearwardly from the lower portions 183. The projected nature of the upper portions 181 causes the panels 72a-e to be rearwardly offset relative to the front walls 225 of the troughs 78. This causes the panels 72a-e to overhang the front walls 225 of the troughs 78. By rearwardly offsetting the panels 72a-e, the cross-connect connectors at the rear side of the panels 72a-e are made more accessible. The panel offset also recesses the front sides of the panels 72a-e from the main open interior volume of the bay. In this way, cables 75 routed within the interior volume of the bay are prevented from being damaged by potentially sharp contacts located at the front sides of the panels 72a-e.

The brackets 181 function to offset the panels 72a-e and the troughs 72 from the rack rails 53 to provide more open space for routing cables 75 within the bay 31. Additionally, the brackets 181 block the sides of the interior volume of the bay to hide the cables routed within the bay from view. Cable tie-down openings 187 are defined by the brackets 181 for use in tying and bundling cables 75 routed through the bay 31.

As shown at FIG. 4, the troughs 78 also are connected to the rack rails 53 of the bay 31 by brackets 160. The brackets 160 are undercut to provide side openings 161 that facilitate routing cables between the horizontal troughs 78 and the vertical troughs 88. When multiple bays are mounted side-by-side to form a row of bays, the open ends 183 of the horizontal troughs allow cross-connect cables to be readily routed from bay-to-bay. In this way, cross-connect cables/jumpers from different bays in a row can easily be routed between bays and terminated to the appropriate panels 72a-e.

As shown at FIG. 4, vertical troughs 88 of the bay 31 are forwardly offset from the horizontal troughs 78. The vertical troughs 88 allow cables to be routed from one horizontal trough (e.g. the lowermost trough 78) to another horizontal trough, (e.g. the uppermost channel 78). Thereby the cables within the cross-connect termination region 70 are contained within the bay 31 and do not have to be routed along an exterior side of the bay. The front walls 225 of the troughs 78 as well as the panels 72a-d extend between the rack rails 53 and terminate at the inner flanges 227 of the rails 53. Thus, the walls 225 and the panels 72a-e do not block rear access to the channels 88 of the rails 53 thereby providing open access regions 86 (FIG. 4) adjacent the ends of the troughs 78. The access regions 86 define open space for routing cables forwardly/rearwardly between the vertical troughs 88 and the horizontal troughs 78.

As shown at FIGS. 5, 12, 13 and 19, the panels 72a-e define horizontal rows of openings 128 in which cable termination elements (e.g., co-axial connectors such as BNC connectors) can be secured. For clarity, the majority of the Figures do not show connectors mounted within the openings 128. One notable exception is FIG. 13, where connectors are shown mounted within the openings 128 defined by the uppermost cross-connect panel 72a. In one embodiment, the connectors include snap-fit housings 91 (see FIG. 13) for retaining the connectors within the openings 128.

In use, connectors mounted to the cross-connect panels 72a-e are intended for connection to cross-connect cables/jumpers. Hence, as shown in FIG. 11, these connectors (depicted as BNC connectors) have been labeled 126_{X-IN} and 126_{X-OUT}. Each of the panels 72a-e includes 6 horizontal rows of connectors. The rows have been labeled R1-R30 at FIG. 19.

FIG. 11 schematically shows a pair of connectors 126_{X-IN}, 126_{X-OUT} mounted within openings 128 in one of the cross-connect panels 72. At a rear side 182 of the panel 72, the connectors 126_{X-IN}, 126_{X-OUT} are exposed for ready access by a user. At a front side 184 of the panel 72, the connectors 126_{X-IN}, 126_{X-OUT} are terminated to cables 75 that electrically connect the connectors 126_{X-IN}, 126_{X-OUT} to their corresponding jack module 61. It will be appreciated that the front side 184 of the panel 72 faces the open cable passage region 137 defined by the bay (e.g., between the vertical support channels 53).

Referring to FIGS. 4 and 13, the cross-connect region 70 preferably includes at least one cable management device. The cable management device can include, for example, tie down bars, rings, fingers, loops, brackets, or punch-out areas. In the illustrated embodiment, cable management is provided by a bracket arrangement including and first and second cable management brackets 164, 166 oriented at generally a right angle relative to one another. Each of the brackets 164, 166 defines a loop or ring for receiving cables. The first cable management bracket 164 of each of the bracket arrangements 162 is aligned generally parallel to its corresponding panel 72 and is positioned directly behind the open side of its corresponding vertical trough 88. The second cable management bracket 166 projects rearwardly from its corresponding panel 72 and is positioned above its corresponding horizontal trough 78. Bracket 164 prevents cables CA₂ routed directly from the panel 72 to the vertical trough 88 from falling downwardly to block the access opening 86. Bracket 166 prevents cables routed to the panel 72 from blocking the horizontal trough 78 located below the panel 72.

In the depicted embodiment, the panels 72a-e are not angled. In alternative embodiments, the panels 72a-e can be angled so as to match the left and right angling of the panels 62a-e and 63a-e.

d. Tracer Lamp Circuitry

The present embodiment further accommodates tracer lamp circuitry for testing or diagnostic purposes. Referring to FIGS. 3A and 11, the chassis 32 includes a plurality of tracer lamps 190 associated with each of the jack modules 36. The tracer lamps 190 can be lit by activating a switch 192 located adjacent to each of the tracer lamps 190. The tracer lamps 190 assist in quickly visually identifying two jack modules that have been cross-connected together. Tracer lamps 190 can also be provided at the rear of the bay 31 to identify, from the rear, the termination locations of a given cross-connect jumper.

Referring to FIG. 11, tracer lamps 190 are provided at the front and back of the bay 31. When the switch 192 is activated, both lamps 190 are illuminated. In addition, by running a tracer wire from pin jack 193 corresponding the jack module 36 to a pin jack corresponding a jack module to which the module 36 is cross-connected, tracer lamps 190 corresponding to both modules are illuminated by activating switch 192.

In addition, the present system provides for cross-aisle tracing. As shown at FIG. 14, cross-aisle tracing can be accomplished by running a tracer line from pin jack 193 provided at the cross-connect region 70 of bay 31a to a pin jack 195 provided at the cross-aisle region 200 of bay 31a. The pin jack 195 is wired within the bay 31a to a wire wrap pin header 197 (partially shown in FIG. 3) provided at the front of the bay adjacent the top of the bay. Cross-aisle tracing is provided by running a wire-wrap tracer line 199 from the header 197 to a corresponding header 197 provided at bay 31b. Similar to bay 31a, the header 197 of bay 31b is wired to a pin jack 195 provided at a cross-aisle region 200 of bay 31b. A tracer line from pin jack 195 to a pin jack 193 at a cross-connect region 70 of the bay 31b completes the tracer pathway. When the switch 192 of either jack inserts 36 of the bays 31a, 31b is activated, the tracer lamp 190 associated with each of the particular jack modules 36, and the corresponding panel tracer lamps 198 of each of the termination panels 72 of both bays 31a, 31a, illuminate to trace the cross-connections.

II. Chassis

The plurality of chassis 32 of the present system 30 typically includes about 10-20 chassis. In the illustrated embodiment, the bay 31 is configured to receive fifteen chassis 32 numbered C1-C15. Each of the chassis 32 is configured to accommodate 36 jack modules. The bay 31 of the illustrated system 30 includes standard sized BNC connectors and accommodates a total of 540 IN-XIN circuits and 540 OUT-XOUT circuits (15 chassis each having 36 jack modules) having BNC connectors. Other chassis sizes, bay sizes and circuit densities are within the scope of the present disclosure. For example, by using miniature coaxial connectors and miniature coaxial modules, higher circuit densities can be achieved (e.g., at least 720 circuits per bay).

In one non-limiting embodiment, chassis C1 is wired to rows R1 and R2 of panels 62a, 63a, and is also wired to rows R1 and R2 of panel 72a. Chassis C2 is wired to rows R3 and R4 of panels 62a, 63a, and is also wired to rows R3 and R4 of panel 72a. Chassis C3 is wired to rows R5 and R6 of panels 62a, 63a, and is also wired to rows R5 and R6 of panel 72a. Chassis C4 is wired to rows R7 and R8 of panels 62a, 63a, and is also wired to rows R7 and R8 of panel 72b. Chassis C5 is wired to rows R9 and R10 of panels 62a, 63a, and is also wired to rows R9 and R10 of panel 72b. Chassis C6 is wired to rows R11 and R12 of panels 62b, 63b, and is also wired to rows R11 and R12 of panel 72b. Chassis C7 is wired to rows R13 and R14 of panels 62b, 63b, and is also wired to rows R13 and R14 of panel 72c. Chassis C8 is wired to rows R15 and R16 of panels 62b, 63b, and is also wired to rows R15 and R16 of panel 72c. Chassis C9 is wired to rows R17 and R18 of panels 62b, 63b, and is also wired to rows R17 and R18 of panel 72c. Chassis C10 is wired to rows R19 and R20 of panels 62b, 63b, and is also wired to rows R19 and R20 of panel 72d. Chassis C11 is wired to rows R21 and R22 of panels 62c, 63c, and is also wired to rows R21 and R22 of panel 72d. Chassis C12 is wired to rows R23 and R24 of panels 62c, 63c, and is also wired to rows R23 and R24 of panel 72d. Chassis C13 is wired to rows R25 and R26 of panels 62c, 63c, and is also wired to rows R25 and R26 of panel 72e. Chassis C14 is wired to rows R27 and R28 of panels 62c, 63c, and is also wired to rows R27 and R28 of panel 72e. Chassis C15 is wired to rows R29 and R30 of panels 62c, 63c, and is also wired to rows R29 and R30 of panel 72e. Of course, the wiring scheme can be varied from that described above to meet customer preferences.

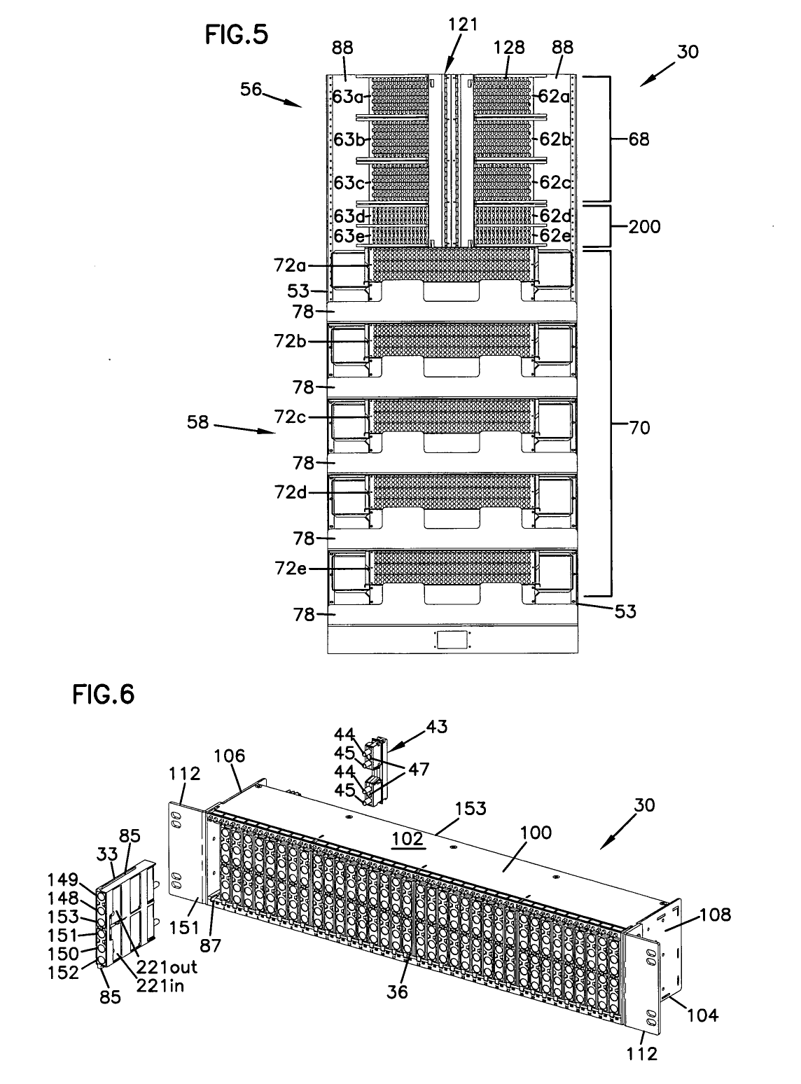

Referring now to FIG. 6, the chassis 32 of the DSX system 30 includes a chassis housing 100 having a front or front side 151 and a rear side 153. A top wall 102 and a bottom wall 104 extend between the front side 151 and the back side 153 of the chassis housing 100. The top and bottom walls 102, 104 are interconnected by sidewalls 106, 108. In the illustrated embodiment, mounting flanges 112 extend from the sidewalls 106, 108 adjacent the front side 151 of the chassis housing 100. The mounting flanges 112 are used to mount the chassis 32 to the bay 31 (FIG. 3). Preferably, the chassis 32 is mounted to the bay 31 such that the front side 151 of the chassis corresponds to the front side 52 of the bay 31, and the rear side 153 of the chassis faces the rear side 54 of the bay 31.

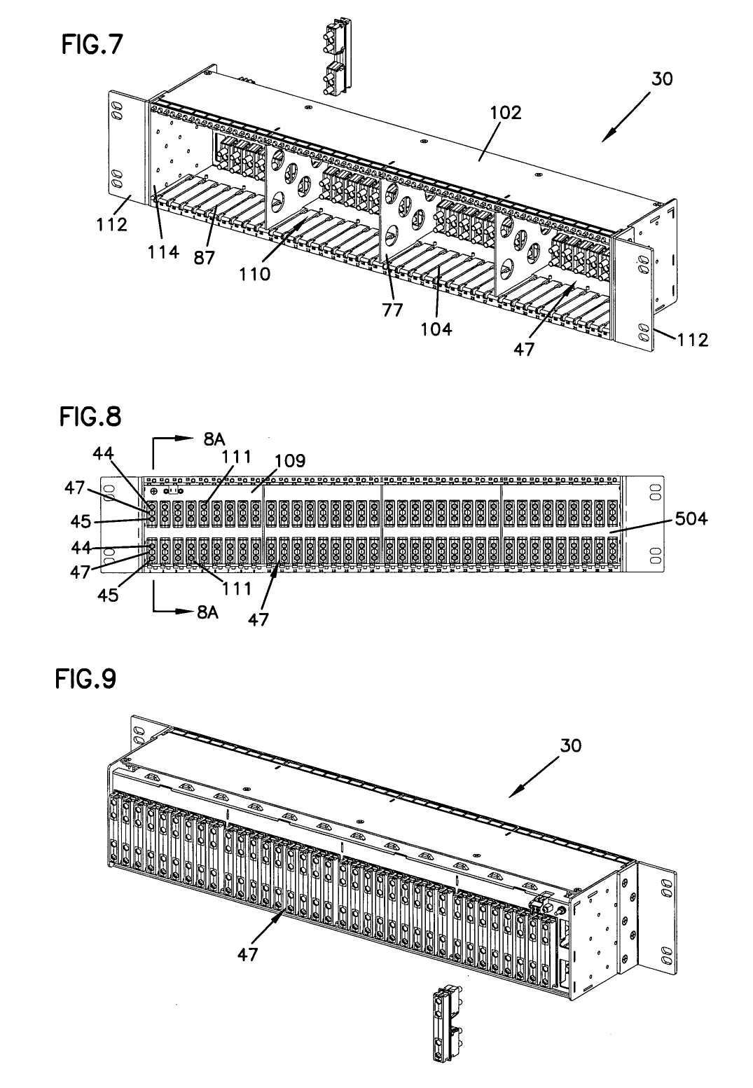

The chassis 32 includes a rear interface assembly 47 (shown at FIGS. 7-9) for electrically connecting the jack modules 36 to cables 65, 75 respectively routed to the IN/OUT region 68 and the cross-connect region 70 (see FIG. 11). The rear interface assembly includes a plurality of rear interface units 43 (see FIG. 6). The cables 65, 75 are electrically connected to rear sides of the units 43. Connectors 44, 45 are provided at front sides of the units 43. When jack modules 36 are inserted into the chassis, the connectors 44, 45 plug into the jack modules 36 to provide electrical connections between the cables 65, 75 and the jack modules 36.

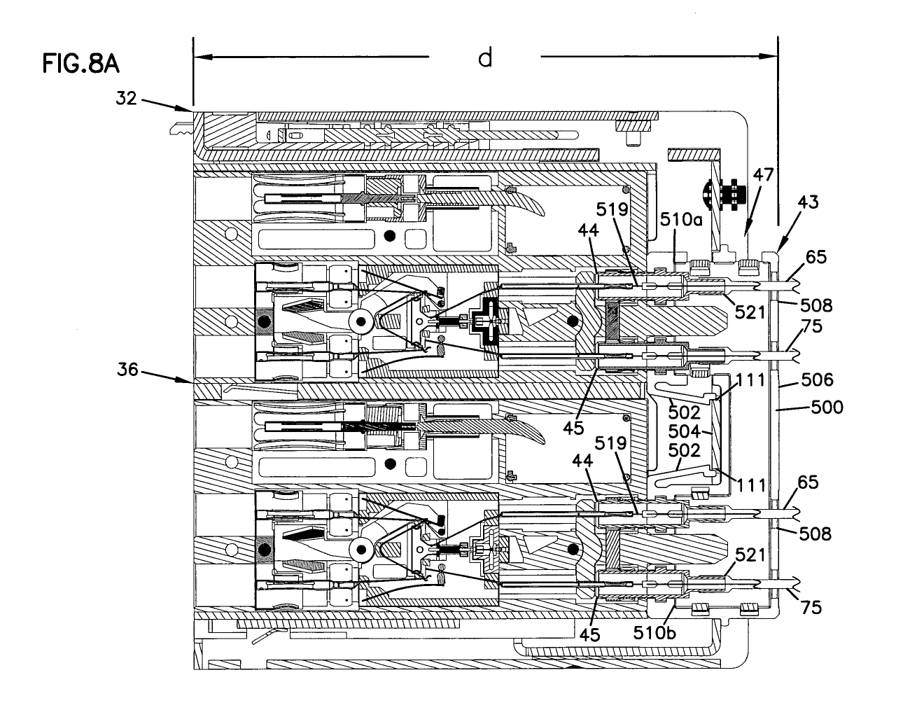

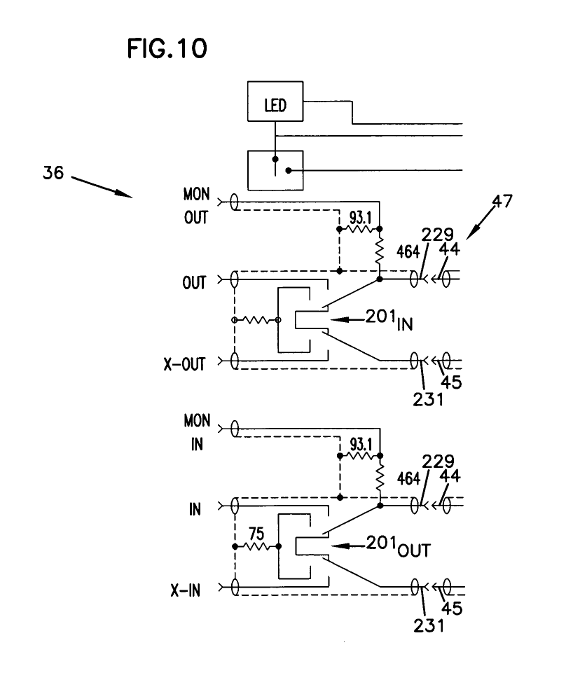

Referring now to FIG. 7, the top and bottom walls 102, 104 and the sidewalls 106, 108 cooperate to define an interior 110 for receiving the jack modules 36. The jack inserts 36 mount side-by-side within the chassis 32. In the illustrated embodiment, partitions 77 (FIG. 7) are located within the interior 110 of the chassis 32. The interior 110 has a front opening 114 located adjacent the front side 151 of the housing 100. A back wall 109 (FIG. 8) extends between the top wall 102 and the bottom wall 104 of the housing 100. The back wall 109 includes a plurality of apertures 111. The apertures 111 are arranged to receive the front connectors 44, 45 of the rear interface units 43. In this way, the connectors 44, 45 are positioned to connect with the jack modules 36 when the modules are inserted within the chassis 32.

As shown at FIGS. 6 and 8A, each of the interface units 43 includes a dielectric housing 500 that mounts to the rear of the chassis 32. For example, as shown at FIG. 8A, the housings 500 each include retaining fingers 502 that provide a snap fit connection with the housing 500. The fingers 502 engage a strip 504 of the chassis 32 located between the vertically spaced apart apertures 111. By deflecting the fingers 502 toward one another (e.g., by removing the module 36 and accessing the fingers 502 through the front of the chassis 32) the units 43 can be removed from the chassis 32. The housings 500 also include rear walls 506 defining openings 508 through which the cables 65, 75 pass to enter the housing 500. The housings 500 further include front connector mounts for mounting the connectors 44, 45 terminated to the cables 65, 75. The front connector mounts include upper mounts 510a adapted to fit within the upper apertures 111 of the chassis 32, and lower connector mounts 510b adapted to fit within the lower openings 119. Two of the connectors 44, 45 are secured to each of the mounts 510a, 510b.

Referring still to FIG. 8A, the cables 65, 75 have center conductors terminated to center pins 519 of the connectors 44, 45, and reinforcing braids and sheaths 521 crimped to rear ends 512 of the connectors 44, 45.

The chassis 32 preferably has a depth d sufficiently small to provide a relatively large area within the interior of the bay for routing cable. In one non-limiting embodiment, the depth d is less than 7 inches. In another non-limiting embodiment, the depth d is less than 6 inches. In still another non-limiting embodiment, the depth d is less than 5 inches.

III. DSX Jack Modules

Referring now to FIGS. 6, the jack modules 36 of the DSX system 30 are removably inserted into the chassis 32 from the front side 151 of the chassis. As shown in FIG. 6, the illustrated jack module 36 includes a frame 33 including upper and lower guide rails 85. The guide rails 85 correspond to slots 87 (only one lower slot shown) formed in the chassis 32 to guide the jack insert 32 within the interior 110 of the chassis 32. The modules 36 can be retained within the chassis 32 by any number of techniques such as latches, fasteners, snap-fit connections or other fastening techniques.

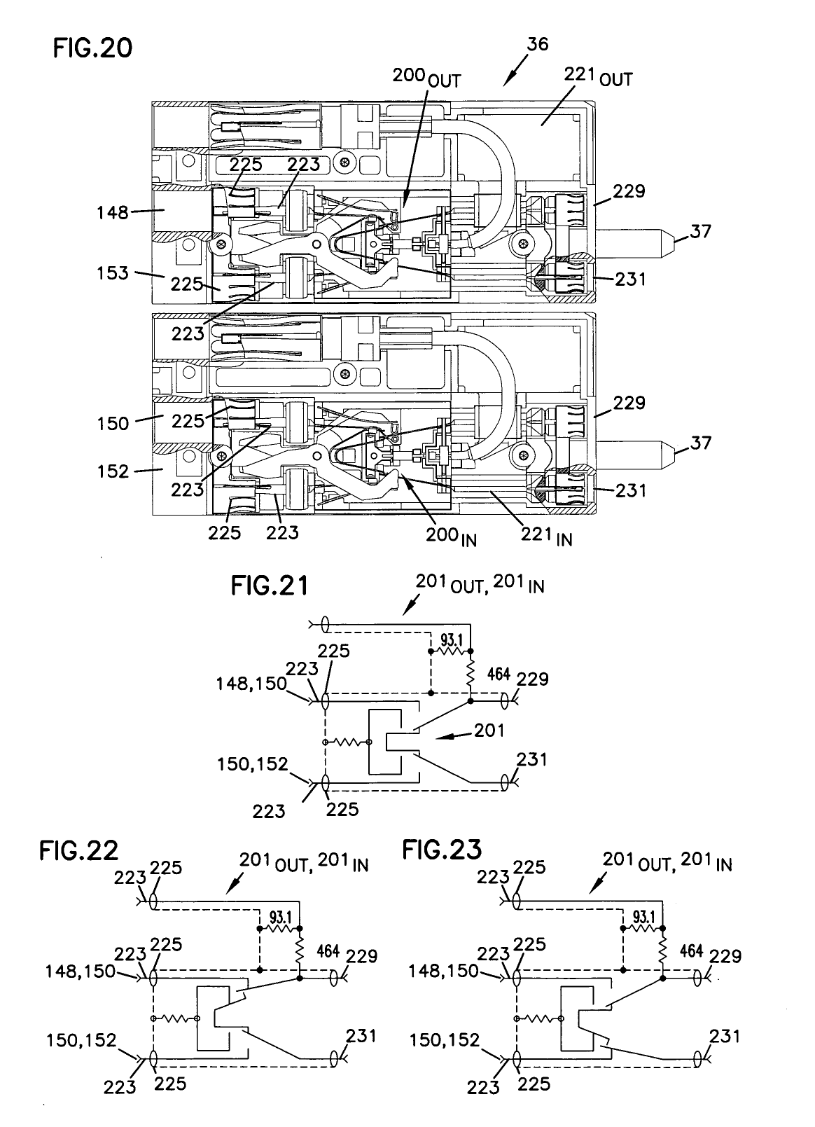

Still referring to FIG. 6, each of the jack modules 36 includes an OUT port 148, a MONITOR-OUT port 149, an IN port 150, a MONITOR-IN port 151, a CROSS-CONNECT IN port 152 and a CROSS-CONNECT OUT port 153. The ports 148-153 are defined by the front sides of a pair of jack inserts 221_{OUT}, 221_{IN} mounted within the frame 33. The jack inserts 221_{OUT}, 221_{IN} are of the type described in U.S. Pat. No. 6,589,062, which is incorporated herein by reference. The rear sides of the jack inserts 221_{OUT}, 221_{IN} are adapted to interface with the rear interface assembly of the chassis 32. For example, as shown at FIG. 20, the rear sides of the jack inserts 221_{OUT}, 221_{IN} include connectors 229, 231 that connect with the connectors 44, 45 of the rear interface units when the jack modules 36 are inserted in the chassis 32. The rear sides also include alignment posts 37 that fit within alignment openings 47 defined by the rear interface units. Referring to FIG. 20, the jack inserts 221_{OUT}, 221_{IN} include center conductors 223 and sleeve contacts 225 corresponding to each of the ports 148-153. In this way, the jack inserts 221_{OUT}, 221_{IN} include connection interfaces that are compatible with coaxial connectors inserted within the ports 148-153.

As shown in FIG. 20, the jack inserts also include switching circuitry 201_{OUT}, 201_{IN} that normally provide through connections between the connectors 229, 231. The switching circuitry 201_{OUT} breaks the normal through circuit pathway of the jack insert 221_{OUT} when a co-axial plug is inserted into either of the ports 148, 153. The switching circuitry 201_{IN} breaks the normal through circuit pathway of the jack insert 221_{IN} when a co-axial plug is inserted into either of the ports 150, 152. FIG. 21 schematically shows the normal-through switch connection provided between the connectors 229, 231 when no plugs are inserted in the ports 148, 150, 152, 153. FIG. 22 shows that when a plug is inserted in the port 148, 150, the normal through connection between connectors 221, 231 is broken. Instead, connector 221 is connected to the center conductor of port 148, 150, and connector 231 is connected to ground. FIG. 23 shows that when a plug is inserted in the port 152, 153, the normal through connection between connectors 221, 231 is broken. Instead, connector 231 is connected to the center conductor of port 152, 153, and connector 221 is connected to ground.

As used herein, the term coaxial connector includes connectors adapted for terminating co-axial cables. Coaxial connectors generally include a center conductor and a shield contact offset from the central conductor. Example co-axial connectors include BNC connectors, 1.6/5.6 connectors or SMB connectors, or other connectors or other miniature co-axial connectors such as mini-coaxial connectors sold by ADC Telecommunications, Inc. An example miniature co-axial jack system is disclosed at U.S. Pat. No. 5,467,062, which is incorporated herein by reference.

Since many embodiments of the invention can be made without departing from the spirit and scope of the invention, the invention resides in the claims hereinafter appended.

What is claimed is:

1. A telecommunications bay comprising:
a frame having a front and a rear;
at least first and second chassis mounted at the front of the frame;
a first grouping of co-axial connectors including IN and OUT coaxial connectors accessible from the rear of the frame;
a second grouping of co-axial connectors including CROSS-CONNECT IN and CROSS-CONNECT OUT coaxial connectors accessible from the rear of the frame, the first grouping of coaxial connectors being separate from the second grouping of coaxial connectors;
first normal-through switching circuitry housed within the first chassis, the first normal-through switching circuitry being electrically connected to IN and OUT connectors of the first grouping and to CROSS-CONNECT IN and CROSS-CONNECT OUT connectors of the second grouping;
second normal-through switching circuitry housed within the second chassis, the second normal-through switching circuitry being electrically connected to IN and OUT connectors of the first grouping and to CROSS-CONNECT IN and CROSS-CONNECT OUT connectors of the second grouping;
ports that provide plug access to the first and second normal-through switching circuitry; and
center conductors and shield contacts corresponding to the ports for providing electrical connections with coaxial plugs inserted within the ports.

2. The telecommunications bay of claim 1, wherein the first and second chassis each include rear electrical interfaces, and wherein interior coaxial cables are routed from the rear electrical interfaces through an interior of the frame to the first and second groupings of coaxial connectors.

3. The telecommunications bay of claim 2, wherein the frame includes first and second vertical rack rails, and wherein the interior coaxial cables are routed between the rack rails.

4. The telecommunications bay of claim 3, wherein the rack rails define vertical cable management troughs.

5. The telecommunications bay of claim 4, wherein the first and second groupings of coaxial connectors are positioned generally between the first and second rack rails.

6. The telecommunication bay of claim 5, further comprising a horizontal cable management trough located adjacent the second grouping of connectors, the horizontal cable management trough being rearwardly offset from the first and second rack rails.

7. The telecommunications bay of claim 6, wherein the first grouping of coaxial connectors is located adjacent an upper region of the frame and the second grouping of coaxial connectors is located adjacent a lower region of the frame.

8. The telecommunications bay of claim 1, wherein the first grouping of coaxial connectors is located adjacent an upper region of the frame and the second grouping of coaxial connectors is located adjacent a lower region of the frame.

9. The telecommunications bay of claim 1, wherein the first grouping of coaxial connectors is provided at a panel structure having a first panel region aligned at an angle relative to a second panel region.

10. The telecommunications bay of claim 9, wherein the IN coaxial connectors are provided at the first panel region and the OUT coaxial connectors are provided at the second panel region.

11. A telecommunications bay comprising:
a frame having a front and a rear;
a plurality of chassis mounted at the front of the frame;
an IN/OUT cable termination region accessible from the rear of the frame;
a cross-connect cable termination region accessible from the rear of the frame, the cross-connect cable termination region being segregated from the IN/OUT cable termination region;
normal-through switching circuitry housed within the chassis, the normal-through switching circuitry of each chassis being electrically connected to the IN/OUT cable termination region by first cables that extend through an interior region of the frame, and the normal-through switching circuitry of each chassis being electrically connected to the cross-connect cable termination region by second cables routed through the interior region of the frame;
ports that provide plug access to the normal-through switching circuitry; and
center conductors and shield contacts corresponding to the ports for providing electrical connections with coaxial plugs inserted within the ports.

12. The telecommunications bay of claim 11, wherein the IN/OUT cable termination region is located at an upper portion of the frame, and the cross-connect cable termination region is located at a lower portion of the frame.

13. The telecommunications bay of claim 1 1, further comprising a connector mounting construct positioned at the IN/OUT cable termination region, the connector mounting construct including first and second connector mounting sections aligned at angles relative to one another, wherein IN and OUT connectors are mounted to the first and second connector mounting sections.

14. The telecommunications bay of claim 13, wherein the first and second connector mounting sections are each defined by one or more panels having openings defined therein.

15. The telecommunications bay of claim 13, wherein the IN and OUT connectors are segregated within the IN/OUT cable termination region with the IN connectors being mounted at the first connector mounting section and the OUT connectors being mounted at the second connector mounting section.

16. The telecommunications bay of claim 13, wherein cross-aisle connectors are mounted at the first and second mounting sections.

17. The telecommunications bay of claim 11, wherein the cross-connect cable termination region includes a plurality of vertically spaced apart cross-connect connector mounting panels, and wherein a horizontal cable management trough is located beneath each of the cross-connect connector mounting panels.

18. The telecommunications bay of claim 17, wherein the frame includes first and second vertical rack rails each defining a vertical cable management trough having an open side that faces in a rearward direction, wherein the cross-connect connector mounting panels are positioned to extend across a width of the frame between the first and second mounting rails, wherein the horizontal cable management troughs are positioned rearward of the first and second rack rails, and wherein the bay defines open access regions for routing cables between the horizontal cable management troughs and the vertical cable management troughs.

19. The telecommunications bay of claim 18, wherein the cross-connect connector mounting panels at least partially overhang the horizontal cable management troughs.

20. The telecommunications bay of claim 18, wherein the open access regions are located adjacent ends of the cross-connect connector mounting panels, and wherein the bay includes first sets of cable management rings that project rearwardly from the cross-connect connector mounting panels adjacent the ends of the cross-connect connector mounting panels, and second sets of cable management rings that project laterally from the ends of the cross-connect connector mounting panels so as to extend at least partially across the open access regions.

21. The telecommunications bay of claim 18, wherein the IN/OUT cable termination region is located adjacent a first vertical segment of the vertical rack rails, and the cross-connect cable termination region is located adjacent a second vertical segment of the vertical rack rails, wherein equipment cables routed to the IN/OUT cable termination regions through the rack rails do not need to share vertical lengths of rack rail with cross-connect cables routed to the cross-connect cable termination region through the rack rails.

22. A telecommunications bay comprising:
a frame having a front and a rear, the frame including first and second rack rails, each defining a vertical cable management trough having an open side that faces in a rearward direction;
a plurality of chassis mounted at the front of the frame;
an IN/OUT cable termination region accessible from the rear of the frame, the IN/OUT cable termination region including a connector mounting construct mounted to extend across a width of the frame defined between the first and second rack rails, the connector mounting construct having first and second connector mounting sections aligned at angles relative to one another;
a cross-connect cable termination region accessible from the rear of the frame, the cross-connect cable termination region being segregated from the IN/OUT cable termination region, the cross-connect cable termination region including a plurality of vertically spaced apart cross-connect connector mounting panels that extend across the width of the frame defined between the first and second rack rails;
a horizontal cable management trough located beneath each of the cross-connect connector mounting panels, the horizontal cable management troughs being positioned rearward of the first and second rack rails, and the bay defining open access regions adjacent ends of the cross-connect connector mounting panels for routing cables between the horizontal cable management troughs and the vertical cable management troughs; and
normal-through switching circuitry housed within the chassis, the normal-through switching circuitry of each chassis being electrically connected to the IN/OUT cable termination region by first cables that extend through an interior region of the frame, and the normal-through switching circuitry of each chassis being electrically connected to the cross-connect cable termination region by second cables routed through the interior region of the frame.

23. The telecommunications bay of claim 22, wherein the IN/OUT cable termination region is located at an upper portion of the frame, and the cross-connect cable termination region is located at a lower portion of the frame.

24. The telecommunications bay of claim 22, wherein the first and second connector mounting sections are each defined by one or more panels having openings defined therein.

25. The telecommunications bay of claim 22, wherein IN and OUT connectors are segregated within the IN/OUT cable termination region with the IN connectors being mounted at the first connector mounting section and the OUT connectors being mounted at the second connector mounting section.

26. The telecommunications bay of claim 22, wherein cross-aisle connectors are mounted at the first and second connector mounting sections.

27. The telecommunications bay of claim 22, wherein the cross-connect connector mounting panels at least partially overhang the horizontal cable management troughs.

28. The telecommunications bay of claim 22, wherein the bay includes first sets of cable management rings that project rearwardly from the cross-connect connector mounting panels adjacent the ends of the cross-connect connector mounting panels, and second sets of cable management rings that project laterally from the ends of the cross-connect connector mounting panels so as to extend at least partially across the open access regions.

29. The telecommunications bay of claim 22, wherein the IN/OUT cable termination region is located adjacent a first vertical segment of the vertical rack rails, and the cross-connect cable termination region is located adjacent a second vertical segment of the vertical rack rails, wherein equipment cables routed to the IN/OUT cable termination regions through the rack rails do not need to share vertical lengths of rack rail with cross-connect cables routed to the cross-connect cable termination region through the rack rails.
